(19) United States
(12) Patent Application Publication
(10) Pub. No.: US 2011/0001315 A1
(43) Pub. Date: Jan. 6, 2011

(54) TUBE CONNECTION

(75) Inventors: Roland J. Fischer, Uitikon Waldegg (CH); Li Fuzhuang, Jiangmen City (CN)

Correspondence Address: MCCORMICK, PAULDING & HUBER LLP, CITY PLACE II, 185 ASYLUM STREET, HARTFORD, CT, 06103, US

(73) Assignee: Skincom AG, Cham (CH)

(21) Appl. No.: 12/809,342

(22) PCT Filed: Dec. 19, 2007
(86) PCT No.: PCT/EP07/64226

§ 371 Date: Sep. 7, 2010

(51) Int. Cl. F16L 21/00

(52) U.S. Cl. 285/31

(57) ABSTRACT

Tubular structure having at least two tubes (20, 20′) and a plug-in tube connection (10) which comprises a flange (1), wherein said flange (1) serves as an axial stop surface for terminal ends (21, 21′) of the two tubes (20, 20′). Each side of the flange (1) is equipped with at least one lug (3) in order to engage in a corresponding cutout (22) in the terminal end (21, 21′) of the respective tube (20, 20′), wherein the lugs (3) engaging in the cutouts (22) prevent the tubes (20, 20′) from twisting relative to one another. On each side of the flange (1) is provided a cylinder portion (5, 5′) which can be plugged into the inside of the respective tube (20, 20′). In addition, each cylinder portion (5) has an axial gap (7), resulting in flexible endpieces (9A, 9B) above and below the gap. The first flexible endpiece (9A) has a radial bore (11) with a screw element (13) for tightly clamping the tube connection (10) in the tube (20, 20′).

The present invention relates to a tube connection for connecting different tubes, in order to form a self-supporting tubular structure, such as a tent structure, stand building structure for example.

In the field of tent structures and tubular structures within stand building, there are various methods for connecting the tubes of these structures. The simplest of these methods is to insert an end of a tube with a smaller diameter in the corresponding end with a larger diameter of a next tube. However, this method has various limitations as regards the profile of the end of the tubes and can not simultaneously guarantee a solid connection and a simple, easy disassembly. In addition, if the tubes are flexible, such a connection is not reliable because the tubes can become loose.

Other tube connections are also known which are inserted between two tubes and keep the two tubes together by friction. It is a disadvantage of these usually elongated connections that they also can not guarantee a reliable and stable connection and, above all, that they can not prevent the tubes twisting against each other “shear effect”.

The object of the present invention is therefore to provide a tube connection for a tube-like structure which allows a very solid, secure but still easy connection of tubes and can also prevent twisting of the tubes against each other.

This object is solved according to the invention through a cylindrical tube connection, comprising a circumferential flange which acts as an axial stop surface for terminal ends of two tubes and on each side at least one step engaging in a corresponding cutout on the terminal end of the tube to prevent twisting of the tubes against each other. The strength of the connection is guaranteed in that flexible end pieces are provided, which result from gaps provided in the terminal ends of the end pieces. The end pieces each include a radial bore which each receive a screw element. To clamp the tube connection in the interior of the tubes, these screw elements can be screwed through openings in the cylindrical surface of the tube, in order to bend the flexible end pieces apart. The screw elements can also be screwed out a little to attach the tube connection in the cylinder wall.

The main advantage of the invention is that the tube connection can be employed very easily and quickly, and that the connection between the tubes themselves and with the tube connection is still very firm and reliable. Additionally, the tube connection can be easily pulled out from inside the tubes, after the screw element has been screwed in or screwed out.

Another advantage of the invention is the large number of different possible applications where the tube connection may be used. Furthermore, the inventive tube connection can be made in very different sizes and from different materials. For example, if the tubes, which the tube connection is to connect, are flexible and if the whole structure should be flexible, then one can manufacture the tube connection of flexible plastics. This way one can guarantee the flexibility of the entire structure. On the other hand, in very stable structures, such as stages or similar structures and scaffolding, the tube connections are preferably made of metal or fibre reinforced plastic.

Further details and advantages of the invention are described below with reference to embodiments and with reference to the drawing. They show:

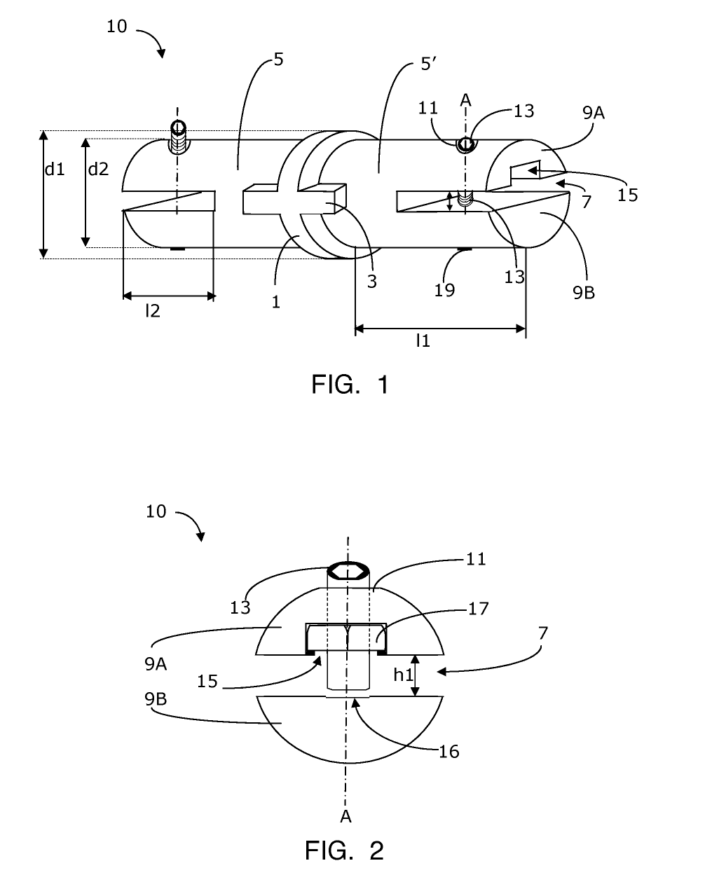

FIG. 1 a schematic perspective view of the tube connection according to the invention;

FIG. 2 a schematic side view of the tube connection according to the invention;

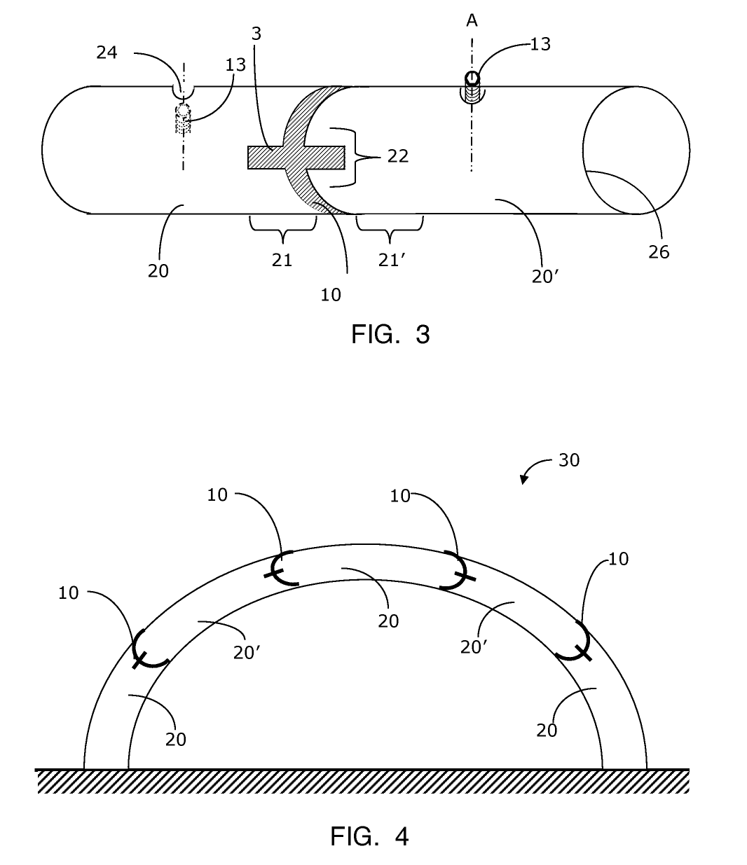

FIG. 3 a schematic perspective view which illustrates how the tube connection connects two tubes, according to the invention;

FIG. 4 a schematic perspective view for illustrating a possible use of a multitude of tube connections according to the invention;

### DETAILED DESCRIPTION

The invention relates to a tube connection 10 for the simple, fast and secure connection of tubes 20, 20′, rods or of generally elongated hollow construction elements. For simplicity, the tubes, rods or generally elongated hollow construction elements shall be referenced in the following with tubes 20, 20′. The invention is particularly suitable for the connection of two hollow tent tubes of larger tents, wherein a multitude of tubes 20, 20′ are connected with several tube connections, in order to build a self-sustaining construction 30 (see for example FIG. 4). According to the invention it relates to one-piece elements (preferably plastic or metal elements) which act as tube connections 10.

The object of the invention is a tubular structure 30 with at least two tubes 20, 20′ and an elongated three-dimensional cylindrical element, the tube connection 10, which is insertable into the inside of a tube 20, 20′. The tube connection 10 connects two tubes 20, 20′, in that one inserts it between two tubes 20, 20′ into the inside of the terminal ends of the tubes 21, 21′ and then, by means of methods described in following paragraphs, securing the tube connection in the inside of the terminal ends 21, 21′.

FIG. 1 shows the preferred embodiment of the tube connection. As FIG. 1 shows, the tube connection 10 comprises in a middle section a circumferential flange 1. This flange 1 has preferably a height (d1−d2)/2 which is approximately identical with the thickness of the cylinder wall 26 (the wall thickness of the tube 20 or 20′), i.e. the diameter d2 is approximately the outer diameter of the tubes 20, 20′. This is preferred in order to make a seamless transition between the tubes 20 and 20′ possible. In case the two tubes 20 and 20′ to be connected have different diameters, a further embodiment of the tube connection is used, which is not symmetrical, i.e. it comprises two cylinder portions 5, 5′ which have different diameters d2. In this case, the central circumferential flange 1 is conical and the diameter on the first side of the flange 1 corresponds to the diameter of the first tube 20 and the diameter on the other side of the flange 1 corresponds to the diameter of the second tube 20′. In this case the tube connection 10 can also be used as a transition element between two different tubes 20, 20′.

The flange also acts as an axial stop surface for the terminal ends 21, 21′ of the tubes 20, 20′, i.e. the sides of the flanges should be adapted precisely to the terminal ends 21, 21′. In the preferred embodiment of the tube connection 10, at least one, but preferably two, lugs 3 are provided on each side of the flange 3. These lugs 3 are directly connected with the flange 1 and preferably have the same height as the flange 1. These lugs 3 are constructed so that they engage in a corresponding cutout 22 on the terminal end 21, 21′ of the respective tube 20, 20′. This particular feature is very important because it solves one of the objectives of the invention. With these lugs 3 engaging in the cutouts 22, a twisting of the tubes 20, 20′ against each other is prevented. The lugs 3 are axial extensions of the expansions of the flange 1 which engage in the corresponding cutouts 22. If these lugs 3 are sufficiently long and firm and they can not move within the cutout 22, then a twisting of the tube 20, 20′ against the tube connection itself is also not possible.

In the most common embodiment of the invention, as FIG. 1 shows, the tube connection 10 is constructed symmetrical to the circumferential flange 1, i.e. the tube connection 10 has a cylinder portion 5, 5′ on each side of the flange 1. These cylinder portions 5. 5′ are insertable in the inside of the respective tubes 20 and 20′, i.e. the diameter d2 of the cylinder portions 5, 5′ approximately corresponds with the inner diameter of the tubes 20, 20′. In order to be able to easily insert the cylinder portions 5, 5′ into the inside of the tubes 20, 20′, the diameter d2 is a little smaller than the inner diameter of the tubes 20, 20′.

In the case when the two tubes 20 and 20′ to be connected have different inner diameters, the two cylinder portions 5, 5′ are not symmetrical, i.e. they also have different diameters d2, so that each cylinder portion 5, 5′ fits into the corresponding tube 20, 20′.

In order to achieve a firm connection between the tubes 20, 20′, it is preferred that the length l1 equates to at least twice the diameter d2. The longer the cylinder portion 5, 5′ is, the smaller the possibility that the cylinder portion 5, 5′ of the tube connection 10 bends/moves in the tube 20, 20′.

Each cylinder portion 5, 5′ features an axial gap 7, which extends from a face surface of the cylinder portions 5, 5′ in the direction of a middle section. The role of this gap 7 is to provide a first flexible endpiece 9A and a second flexible endpiece 9B above and below the gap 7.

The first flexible endpiece 9A is provided with a radial bore 11. Through this radial bore 11, a screw element 13 can be screwed in. For clamping the tube connection 10 in tube 20 or 20′ there are two different possibilities:
a) in the preferred embodiment of the invention, the screw element 13 is screwed in so deep in the radial bore that it presses against the surface 16 of the second flexible endpiece 9B. This pressure then bends the endpieces 9A and 9B apart, and thus the effective second diameter d2 grows. When this pressure on the surface 16 of the second flexible endpiece 9B is sufficiently high and the effective diameter d2 has been sufficiently increased, then the tube connection 10 is firmly clamped within the inside of the tube 20, 20′. The rigidity of the material, out of which the tube connection 10 is manufactured from, determines the length l2 and the height h1 of the gap 7. These parameters, the rigidity of the material, the length l1 and the height h1, define the flexibility of the flexible endpieces 9A, 9B and therefore the increased second diameter d1. The outer surface of the cylinder portions 5, 5′ and the inner surface of the cylinder walls 26 also play a role in the firmness of the connection. The rougher these surfaces are, the firmer the connection between the tubes 20, 20′ and the tube connection 10 is.
b) in a further embodiment of the invention, after the cylinder portions 5, 5′ have been inserted into the inside of the tubes 20, 20′, the screw element 13 is screwed out in order to fix it in the cylinder wall 26. In order to enable a firm connection, in this case the opening 24 can be provided with a thread.

As an auxiliary measure, in case the roughness of the inner surface of the cylinder wall 26 is insufficient, the second flexible endpiece 9B may be fitted with a ridge 19 which clamps into a corresponding dimple of the tube 20 or 20′. But this ridge 19 of the endpiece 9B should not be too high, so as not to prevent the insertion of the cylinder portions 5 or 5′ in the inside of the tube 20 or 20′, i.e. that d2 including this ridge 19 is not larger than the inner diameter of the tube 20, 20′, or if it is larger, then the flexibility of the endpieces 9A, 9B must compensate for this diameter difference.

FIG. 2 shows that, in the preferred embodiment of the invention, the first flexible endpiece 9A comprises a groove 15 which receives a screw nut 17. The screw element 13 can be screwed into this screw nut 17. This supplementary measure is particularly advantageous when the material out of which the tube connection 10 is made of is a soft material which does not allow a firm connection. This screw nut 17 is also required when the tube connection must be reusable, i.e. when the threads may not wear out.

FIG. 3 shows the use of the tube connection 10, after it has been inserted into the tubes 20, 20′. On the left side one can see based on case a) that the screw element 13 has been screwed in, in order to increase the effective diameter d2 of the cylinder portion. On the right side case b) is shown. The screw element 23 has been screwed out here, in order to fix it within the cylinder wall 26.

FIG. 3 also shows how the lugs 3 engage into the corresponding cutouts 22 on the terminal ends 21, 21′ in the cylinder wall surfaces 26 of the respective tubes 20, 20′. This feature prevents that the tubes 20, 20′ twist against each other and gives the entire structure a great stability.

A particularly advantageous use of the tube connection 10 is shown on FIG. 4. This figure shows multiple tubes 20, 20′ which are connected with multiple tube connections 10 and build a self-supporting load carrying structure 30. According to the invention, such load carrying structures 30 can be employed to construct tents, parasols, pavilions, exposition stands or to build other constructions with elongated supporting elements, such as stages or scaffolding for example.

1-10. (canceled)

11. Tubular structure with at least two tubes (20, 20′) and a pluggable tube connection (10), characterized in that the tube connection (10) is a single-piece element, which:
is elongated and cylindrical,
comprises a middle section with a circumferential flange (1), wherein this flange (1) acts as an axial stop surface for the terminal ends (21, 21′),
in the area of the flange (1) on each side of the flange (1) it comprises at least a lug (3) in order to engage with a corresponding cutout (22) in the terminal end (21, 21′) of the respective tube (20, 20′), wherein the lugs (3) engaging in the cutouts (22) prevent a twisting of the tubes (20, 20′) relative to one another,
is provided on each side of the flange (1) with a cylinder portion (5, 5′), which in insertable into the inside of the respective tube (20, 20′),
each cylinder portion (5, 5′) comprises an axial gap (7), which extends from a face surface of the cylinder portions (5, 5′) in the direction of a middle section, wherein above and below the gap a first flexible endpiece (9A) and a second flexible endpiece (9B) result,
that the first flexible endpiece (9A) comprises a radial bore (11) with a screw element (13) for clamping the tube connection (10) in the tube (20, 20′), wherein the screw element (13) is accessible through an opening (24) in the cylinder wall (26) of the tube (20, 20′).

12. Tubular structure according to claim 1, characterized in that the gaps (7) run parallel to the longitudinal cylinder axis of the cylinder portions (5, 5′).

13. Tubular structure according to claim 1, characterized in that
the circumferential flange (1) has a first diameter (d1),
the cylinder portions (5, 5′) have a second diameter (d2),
the second diameter (d1) is larger than the second diameter (d2).

14. Tubular structure according to claim 3, characterized in that
the first diameter (d1) is approximately the outer diameter of one of the tubes (20, 20′),
the second diameter (d2) is approximately the inner diameter of one of the tubes (20, 20′),
the difference between the first diameter (d1) and the second diameter (d2) is approximately equal with the thickness of the cylinder wall (26).

15. Tubular structure according to claim 1, characterized in that when it is screwed in, the screw element (13) bends the endpieces (9A, 9B) apart, and thereby the effective second diameter (d2) is enlarged, in order to clamp the tube connection (10) in the tube (20, 20′).

16. Tubular structure according to claim 1, characterized in that the screw element (13) extends from the cylinder portion (5, 5′) through the opening (24) in the cylinder wall (24), in order to clamp the tube connection (10) in the tube (20, 20′).

17. Tubular structure according to claim 1, characterized in that the first flexible endpiece (9A) comprises a groove (15) which receives a screw nut (17) in which the screw element (13) can be screwed in.

18. Tubular structure according to claim 1, characterized in that the second endpiece (9B) comprises a ridge (19) which clamps in a corresponding dimple of the tube (20, 20′).

19. Tubular structure according to claim 1, characterized in that multiple tubes (20, 20′) are connected with tube connections (10), in order to build a self-supporting load carrying structure (30).

20. Tent or scaffolding with at least one tubular structure according to claim 1.
